(19) United States
(12) Patent Application Publication
(10) Pub. No.: US 2005/0239349 A9
(43) Pub. Date: Oct. 27, 2005

(54) Medical products with limited use aspect

(76) Inventor: Kai Desinger, Berlin (DE)

Correspondence Address: Beck & Tysver, P.L.L.C.;Suite 100, 2900 Thomas Avenue, Minneapolis, MN, 55416, US

(21) Appl. No.: 10/726,325

(22) Filed: Dec. 1, 2003

Related U.S. Application Data
(63) Continuation of application No. PCT/EP02/05766, filed on May 24, 2002.

(30) Foreign Application Priority Data
Jan. 6, 2001 (DE) 101 26 950.1

(51) Int. Cl. H01R 9/22

(52) U.S. Cl. 439/894

(57) ABSTRACT

The disclosure concerns electrically operated medical products, which are to be brought electrically into operation by being switched on or in conjunction with an electrical power source, including a reuse blocking device that is connectable to the power source and is designed in such a way that when the product is brought into electrical operation for the first time, the reuse blocking device is so initialized and is so altered in its state that operation of the medical product is possible as long as the surgical instrument is connected to the power source or the power source is switched on and the reuse blocking system prevents renewed use after disconnection from the power source or only allows a number of use cycles, which is predetermined by the manufacturer.

### FIELD OF THE DISCLOSURE

The disclosure concerns limiting the use of active medical products or non-active medical products in conjunction with an active medical product. The disclosure relates to a medical product that is to be operated electrically and is to be brought electrically into operation by being switched on or connected to an electrical power source.

In accordance with the disclosure, an amount of use of the medical products of a manufacturer, which is predetermined by the manufacturer, is not exceeded in dependence on the therapy or operational duration. Besides complying with guarantee or warranty claims, this ensures a quality which remains the same for the intended life cycle of the product and thus increases user and patient safety. The disclosure preferably relates to medical products such as instruments, catheters or electrodes (hereinafter referred to as probes) for minimal-invasive or invasive use in and on the patient, and medical implants, (examples include cardiac pacemakers, pacemaker electrodes or stimulation electrodes in neuro surgery). These are used in the short term or the long term in conjunction with active, energy-operated medical units, (examples include high frequency generators, pacemakers, stimulation amplifiers, stimulus current units (hereinafter referred to as generators) on the patient and there apply energy in the form of alternating current.

### BACKGROUND OF THE INVENTION

It often happens in practice that the surgical and sterile instruments, catheters or other medical products that are declared by the manufacturer as being disposable products are repeatedly used on or employed for various patients by the user after renewed re-sterilization (for example gas or steam sterilization at 134° C.) to save costs or otherwise, without in that respect observing the warning notices in the instructions for use relating to the product. Instruments that have been sterilized several times and are not explicitly intended for that purpose represent a potential risk to the patient (for example due to material fatigue caused by sterilization, parts of the instrument can remain in the patient, malfunctions, operational failure, spreading germs/cross-contamination) and also for the user (for example worsened insulation properties on current-carrying handle portions after re-sterilization).

### SUMMARY OF THE INVENTION

This disclosure presents ways of limiting the amount or frequency of use of the disposable products or products with a defined duration of use. The implementations referred to herein involve both the active and also the non-active product.

The object is attained by a medical product comprising a reuse blocking device that is connectable to the power source and is configured such that when the product is brought into electrical operation for the first time, the reuse blocking device is so initialized and is so altered in its state that operation of the medical product is possible as long as the medical product is connected to the power source or the power source is switched on. The reuse blocking device prevents renewed use after disconnection from the power source.

Preferably the reuse blocking device includes at least one ohmic resistor that, when the surgical instrument is first brought into operation, is altered in its resistance or destroyed detector that responds to a deviation in the resistance value from a predetermined range of values and triggers the reuse blocking device so that the medical product is prevented from being brought into operation.

Particularly preferred is a medical product having an electrically operated probe that is connected to a generator as a power source with an electronic monitor that includes the detector. Bringing the probe into electrical operation for the first time represents an initial application. The initial application is characterized by a configuration of the probe and the electronic monitor such that each initial application leads to a change in state at the probe, which is caused by the electronic monitor in the generator. The electronic monitor is preferably adapted to switch off an output of the generator upon the attainment of a predetermined state of the probe prior to the initial application. In that case the electronic monitor is preferably configured such that after an initial application has been implemented the probe can be used as often as desired by the user as long as the probe is still connected to the generator and said generator is switched on or is active.

Preferably, the reuse blocking device includes parallel-connected resistance fuses in the probe, wherein the individual states of the probe are given by the overall resistance of the parallel-connected resistance fuses and a change in state is synonymous with a change in the overall resistance, caused by the failure or melting-through of individual resistors. Alternatively, the changes in state of the probe can be implemented by a variation in a magnetizable probe component, such as a narrow magnetic strip on the probe plug, wherein a change in state is given by an altered direction of magnetization and wherein the generator includes a detection unit which is adapted to detect and alter the direction of magnetization. It is also possible to use other physical effects for that monitoring function and reuse blocking device, such as for example by way of photo-optical or photo-electrical effects (for example a bar code reader), induction reading devices, microchips, or mechanical protection devices which, upon disconnection between the probe and the generator, can exclude improper reuse.

### BRIEF DESCRIPTION OF THE DRAWINGS

FIG. 1 shows an embodiment of the present disclosure in use.

FIG. 2 shows a flow chart for a logic means of a generator electronic monitor as shown in FIG. 1.

### DETAILED DESCRIPTION OF THE DRAWINGS

In accordance with the disclosure, a first simple inexpensive technical implementation (variant 1) is first an introduction, at the probe side, of commercially available, parallel-connected resistance fuses R1, R2, R3, and second a simple resistance detection means (logic means) at the output of the generator, with an additional controlled voltage source, the delivered power of which causes the resistance fuses in the probe to melt through at predefined moments in time.

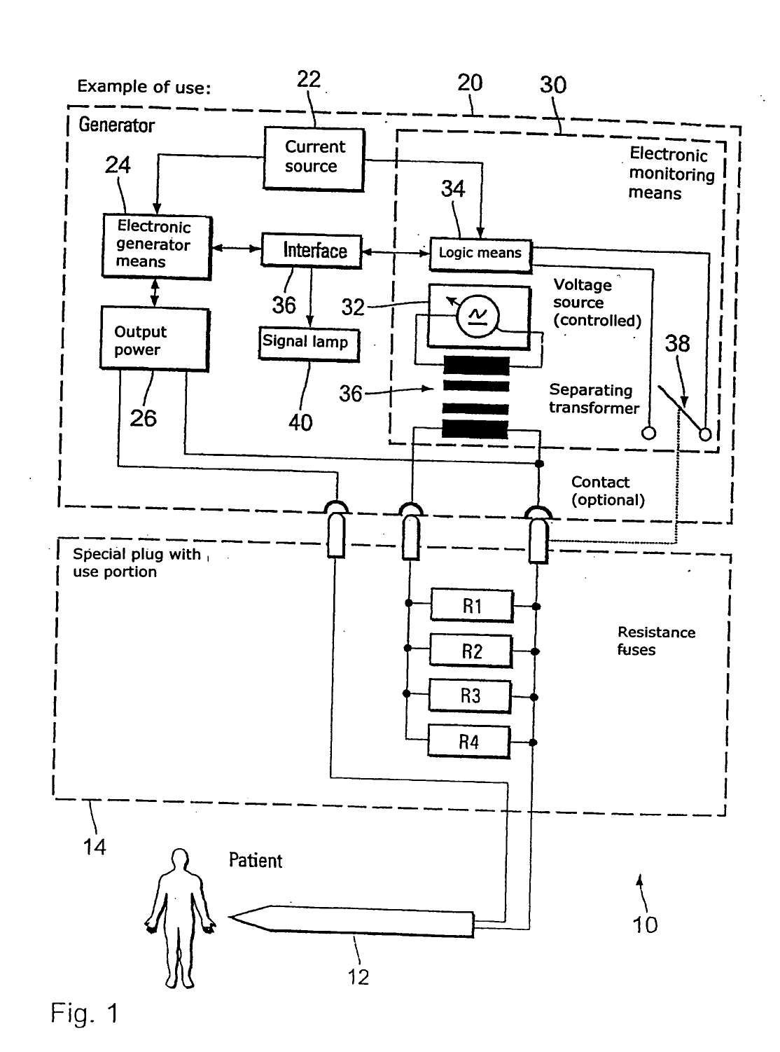

FIG. 1 is a diagrammatic illustration showing a probe 10 with a probe tip 12 for interstitial use and a probe plug 14. Provided in the probe plug are resistance fuses with the resistors R1, R2, R3 and R4. The probe plug is connected to a generator 20, besides the usual generator components such as a current source 22 which feeds an electronic generator means 24 which in turn is connected by way of an output power regulator or switch 26 to contacts for an electrical connection to the probe plug, the generator 20 also has an electronic monitor 30.

The electronic monitor 30 includes a controlled voltage source 32 and a logic means 34. The voltage source 32 is connected by way of a separating transformer 36 to the resistance fuses R1-R4 in the probe plug 14 when the probe plug 14 is connected to the generator 20. The logic means 34 is also connected to the voltage source 32 and also by way of an interface 36 to the electronic generator means 24 of the generator 20. An optional contact 38 which is connected to the logic means 34 serves to signal to the logic means that in actual fact a probe plug 14 is connected to the generator 20.

That installed electronic monitor means is connected to the electronic generator means by way of an interface and decides whether power is to be delivered to the connected probe the frequency of use is embodied by the number and the total resistance of the resistance fuses at the probe side.

In this case the frequency of probe use is counted not on the basis of the individual applications in the patient during a treatment on the basis of how often a probe is used at different treatment times with an operationally ready generator. In other words as long as the probe plug is connected to a switched-on generator, any number of applications can be carried out on the patient. In this case it is only the first application (hereinafter referred to as the initial application) that is counted. In each initial application a resistance fuse is destroyed and the total resistance of the parallel-connected resistors changes.

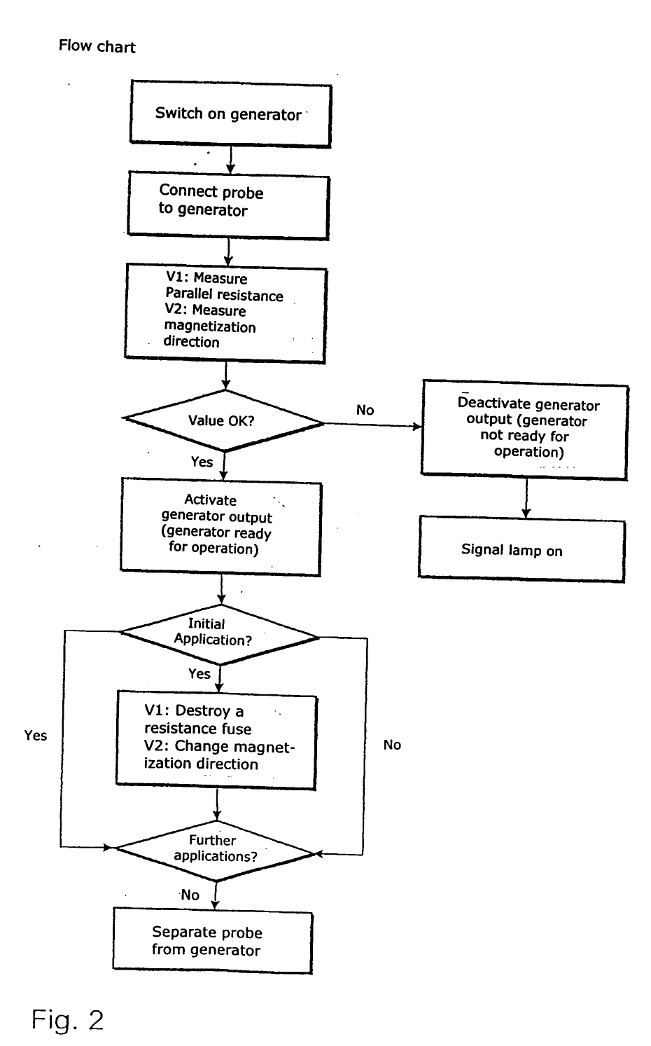

If there is given value for a probe just connected to the generator, the electronic system switches off the delivery of power prior to the first application and no further treatment or use of the product is possible. That is indicated to the user for example by a signal lamp on the generator (see FIG. 2). Probe recognition at the generator output (“is a probe connected to the generator?”) can be implemented by way of the measured parallel resistance or with a switch contact 38 at the output socket that detects the inserted position of the probe plug.

As shown in FIG. 2, operation of the apparatus takes place as follow: the generator is switched on, and a check is made to ascertain whether the probe is connected to the generator (for example by way of the contact 38). The parallel resistance of the resistance fuses is measured. In an alternative variant a direction of magnetization is measured. If the measured value is in the permitted range, the generator output is activated. If the value is outside the admissible range, the generator output is deactivated and a signal lamp 40 is switched on. In that case the reuse blocking device provides that the probe 10 cannot be used again.

Otherwise, if the measured value is in the admissible range and the generator output is activated, a check is made to ascertain whether this involves an initial application. If so, one of the resistance fuses is destroyed or, in the alternative embodiment, a direction of magnetization is altered. A check is made to ascertain whether there is a further application. If the check for the presence of an initial application is answered in the negative, the procedure goes directly to checking whether there is a further application. If that is the case, a check is made once again to ascertain whether the further application is an initial application. If no further application is to be implemented, the probe is disconnected from the generator.

This variant affords several advantages. Among these advantages include:
Due to the use of different resistance combinations, it is possible for different probe types to be detected at the generator side and subjected to further processing as control information.
The frequency of use of the probe can be defined by the number of resistance fuses.
Inexpensive and simple manufacture of the electronic monitoring system.
By virtue of their small size the resistance fuses can be fitted both in the plug portion and also in the handle portion of the probe.

Another possible way of monitoring the frequency of use (variant 2) is the identification of each probe by the provision of a magnetic strip on the probe plug, the direction of magnetization of which is changed after initial application. According to the invention the electronic monitor is also disposed in the generator. When a given direction of magnetization is reached the generator output is deactivated.

A further implementation includes a mechanical or mechanical-electrical securing of the connection between the generator and the probe, which upon first coupling of the (probe and generator) ensures a secure proper transfer of power but which upon subsequent disconnection of the connection is mechanically changed in such a way that renewed coupling of the interface is either mechanically excluded or due to the mechanical change an electrical signal prevents a renewed delivery of power.

Another possibility specifically for the use of implantable active medical products is “impression”, at the apparatus side, of the specific parameters of use in and at the patient, which in accordance with the invention are stored by way of a sensor means/electronic means in the medical product over a defined period of time (for example stimulation parameters, impedance, temperature and so forth). Those items of information serve as a “fingerprint” for the specific ambient and use parameters of the initial area of use. If the medical product is to be operated in another area of use (for example in another patient), the medical product, by way of the logic means for monitoring the frequency of use, recognizes the altered ambient parameters and conditions of use (for example outside the patient, high temperature in the sterilization procedure, in the “new” patient), then the system is switched off and can no longer be activated.

1. An electrically operated medical product for use at and in the patient, which is to be brought electrically into operation by being switched on or connected to an electrical power source, characterized by a reuse blocking device which is connectable to the power source and is designed in such a way that when the product is brought into electrical operation for the first time, the reuse blocking device is so initialized and is so altered in its state that operation of the medical product is possible as long as the medical product is connected to the power source or the power source is switched on or is active and the reuse blocking device prevents renewed operational use of the system after disconnection from the power source.

2. A medical product as set forth in claim 1 characterized in that the reuse blocking device includes at least one ohmic resistor which, when the surgical instrument is first brought into operation, is altered in its resistance or destroyed, and a detector which responds to a deviation in the resistance value from a predetermined range of values and triggers the reuse blocking device so that the medical product is prevented from being brought into operation.

3. A medical product as set forth in claim 1 or claim 2 comprising an electrically operated probe which is connected to a generator as a power source with an electronic monitoring means which includes the detector, wherein bringing the probe into electrical operation for the first time represents an initial application, characterized by a configuration of the probe and the electronic monitoring means such that each initial application leads to a change in state at the probe, which is caused by the electronic monitoring means in the generator.

4. A medical product as set forth in claim 3 characterized in that the electronic monitoring means is adapted to switch off an output of the generator upon the attainment of a predetermined state of the probe prior to the initial application.

5. A medical product as set forth in claim 4 characterized in that the electronic monitoring means is designed in such a way that after an initial application has been implemented the probe can be used as often as desired by the user as long as the probe is still connected to the generator and said generator is switched on.

6. A medical product as set forth in one of claims 1 through 5 and claim 3 characterized in that the reuse blocking device includes parallel-connected resistance fuses in the probe, wherein the individual states of the probe are given by the overall resistance of the parallel-connected resistance fuses and a change in state is synonymous with a change in the overall resistance, caused by the failure or melting-through of individual resistors.

7. A medical product as set forth in claim 1 and claim 3 characterized in that the changes in state of the probe can be implemented by a variation in a magnetizable probe component, preferably a narrow magnetic strip on the probe plug, wherein a change in state is given by an altered direction of magnetization and wherein the generator includes a detection unit which is adapted to detect and alter the direction of magnetization.
